(19) United States
(12) Patent Application Publication
(10) Pub. No.: US 2013/0160775 A1
(43) Pub. Date: Jun. 27, 2013

(54) METHOD AND APPARATUS FOR LOWER BACK PAIN RELIEF

(71) Applicant: Dorothy Curnow, Beaumont (AU)

(72) Inventor: Dorothy Curnow, Beaumont (AU)

(73) Assignee: University of Technology, Sidney, Broadway (AU)

(21) Appl. No.: 13/721,263

(22) Filed: Dec. 20, 2012

(30) Foreign Application Priority Data
Dec. 21, 2011 (AU) 2011905344

(51) Int. Cl. A61H 1/02

(52) U.S. Cl. CPC A61H 1/0292
USPC 128/845

(57) ABSTRACT

A support apparatus (1) adapted for positioning beneath the lower back of a user (2) in a generally semi-supine position. The support apparatus includes a base (5) for positioning on a platform (6) such as a floor. First and second inclined support surfaces (10, 11) are disposed to diverge upwardly from a generally transverse valley formation (12) defined between the first and second support surfaces. The first inclined support surface is adapted for positioning substantially beneath the coccyx or sacrum of the user, the second inclined support surface is adapted for positioning substantially beneath one or more of the thoracic vertebrae of the user, and the valley formation is adapted for positioning substantially beneath one or more of the lumbar vertebrae of the user, thereby to induce a relaxation response in the lower back of a user.

### FIELD OF THE INVENTION

The present invention relates to a method and apparatus for the relief and potential avoidance of lower back pain.

### BACKGROUND OF THE INVENTION

Lower back pain (LBP) is one of the most common pain conditions, affecting approximately 80% of Americans at some point in their lifetime. Approximately five out of ten working adults have some back pain every year. The cause of back pain is not always apparent and for approximately 90% of those suffering from this condition, the specific cause cannot be identified. It is estimated that almost $100 billion is spent annually to provide relief from back and neck pain, which in many instances are interrelated,

A wide array of mainstream and alternative medical treatments exist for LBP, ranging from spinal surgery, chiropractic manipulation, physiotherapy, osteopathy, various muscle stretching or relaxation techniques and tailored exercise regimes, through to various forms of medication and drug treatments including anaesthetics and muscle relaxants. However, there is often an element of “trial and error” involved, as to which if any of these and other treatments might be wholly or even partially effective. This process can be time-consuming, inconvenient, expensive and in some circumstances painful. In many cases, no single treatment or combination of known treatments will be fully effective. Moreover, some have undesirable risks or side effects.

It is reasonably well understood that muscle spasms can not only aggravate LBP conditions, but can also cause LBP, Muscle hypertonicity and areas of involuntary contractile muscle tissue (trigger points) may arise and persist for long periods of time, contributing to persistent LBP symptoms. Approximately 80% of LBP is nonspecific or mechanical in nature and muscle hypertonicity is strongly associated with this condition. Stretching the relevant muscles can have undesirable effects, by increasing muscle tension which may in turn produce an undesirable contractile reaction. Therapists have long tried to find ways to relax or ‘turn off’ these areas of activity and current research is exploring ways to initiate the brain's relaxation response. To date, however, little is known in terms of how this might be achieved in a safe, convenient, consistent and reliable way.

In terms of medication, current treatment of back pain varies by etiology or cause, with opioids and other narcotic agents typically being prescribed to patients with more severe or chronic pain. Anti-inflammatory drugs (steroidal or non-steroidal) and muscle relaxants are also commonly used in acute cases. Neurological medications, such as anticonvulsants and antidepressants, are often also prescribed for back pain, typically in combination with other medications. However, patients often progressively develop a tolerance to such drugs over time and consequently, the need for selection of appropriate drugs and adjustment of the associated dosage regimes dictate regular reassessment by the treating physician. This can be inconvenient, time-consuming, expensive and is often only partially effective. Moreover, significant complications can arise as a result of side effects and long-term use, including the potentially serious risk of addiction or dependency.

In short, back pain, and particularly lower back pain, is a major health problem. It is highly pervasive throughout the population, not well understood, difficult to reliably treat, and a significant drain on both public and private health care resources. It is also a cause of significant lost productivity and suffering, particularly in cases of acute or chronic conditions.

It is an object of the present invention to overcome or ameliorate one or more of the disadvantages of the prior art, or at least to provide a useful alternative.

### SUMMARY OF THE INVENTION

Accordingly, in a first aspect, the invention provides a support apparatus adapted for positioning beneath the lower back of a user, the support apparatus including:
a base for positioning on a platform;
first and second inclined support surfaces disposed to diverge upwardly from a generally transverse valley formation defined between the first and second support surfaces;

the first inclined support surface being adapted for positioning substantially beneath the coccyx or sacrum of the user;
the second inclined support surface being adapted for positioning substantially beneath one or more of the thoracic vertebrae of the user; and
the valley formation being adapted for positioning substantially beneath one or more of the lumbar vertebrae of the user;
thereby tending to induce an abnormal curvature in the user's spine.

Preferably, the apparatus is adapted to be used with the user in a generally semi-supine position, with the feet and/or lower legs at least partially elevated.

Preferably, the base is generally flat and the platform on which the base is adapted to rest preferably takes the form of a floor, a bench, a table or the like. In some embodiments, the base may be effectively integral with the platform.

In one embodiment, the first inclined support surface defines a first generally transverse ridge formation, and the second inclined support surface defines a second generally transverse ridge formation.

The apparatus is preferably sized and positioned such that in use, the first ridge is positioned substantially beneath the coccyx or sacrum, the second ridge is positioned substantially beneath the T-8 to T-10 thoracic vertebrae, and the valley formation is positioned substantially beneath the L-4 or L-5 lumbar vertebrae. In this way, the apparatus is preferably sized and shaped so as simultaneously to induce flexion in the lumbar region of the spine and lordosis in the thoracic region of the spine.

Preferably, the first support surface is generally planar and is inclined upwardly at an angle of between 5° and around 45° to the horizontal. More preferably, the first support surface is inclined upwardly at an angle of between 10° and around 30° to the horizontal. Most preferably, the first support surface is inclined upwardly at an angle of between 15° and around 25° to the horizontal, and in some embodiments is ideally inclined at around 20° to the horizontal.

Preferably, the second support surface is generally planar and is inclined upwardly at an angle of between 5° and around 45° to the horizontal. More preferably, the second support surface is inclined upwardly at an angle of between 10° and around 30° to the horizontal. Most preferably, the second support surface is inclined upwardly at an angle of between 15° and around 25° to the horizontal, and in some embodiments is ideally inclined at around 20° to the horizontal.

In one embodiment, the first and second inclined support surfaces intersect to define an included angle at or adjacent the valley formation that is preferably between 100° and around 160°, more preferably between 120° and around 150°, more preferably between 135° and around 145°, and in some preferred embodiments is ideally around 140°.

Preferably, the lowermost region of the valley formation is positioned at a height of between 5 mm and around 60 mm above the base. More preferably, the valley formation is positioned at a height of between 10 mm and around 50 mm above the base. More preferably, the valley formation is positioned at a height of between 20 mm and around 40 mm above the base. In one preferred embodiment, the valley formation is positioned at a height of around 30 mm above the base.

The first ridge defined by the first inclined support surface is disposed at a height that is preferably between 50 mm and around 150 mm, more preferably between 70 mm and around 120 mm, and more preferably still between 80 mm and around 110 mm, above the valley formation. In some embodiments, the first ridge is most preferably disposed at a height that is around 95 mm above the valley formation.

The second ridge defined by the second inclined support surface is disposed at a height that is preferably between 10 mm and around 50 mm, more preferably between 15 mm and around 40 mm, and more preferably still between 20 mm and around 30 mm, above the valley formation. In some embodiments, the first ridge is preferably disposed at a height that is around 25 mm above the valley formation.

The ratio of the height the second inclined support surface to the height of the first inclined support surface (each measured at the uppermost point of the respective ridge relative to the valley) is preferably between 0.10 and around 0.50, more preferably between 0.20 and around 0.40, more preferably between 0.25 and around 0.35, and in some embodiments is most preferably around 0.3.

The projected length of the first inclined support surface is preferably between 150 mm and around 300 mm, more preferably between 180 mm and around 280 mm, and in some embodiments is most preferably between 200 mm and around 250 mm.

The projected length of the second inclined support surface is preferably between 30 mm and around 100 mm, more preferably between 40 mm and around 80 mm, and in some embodiments is most preferably between 50 mm and around 70 mm.

The ratio of the projected length of the second inclined support surface to the projected length of the first inclined support surface is preferably between 0,10 and around 0.50, more preferably between 0.20 and around 0.40, more preferably between 0.25 and around 0.35, and in some embodiments is most preferably around 0.3. It will be appreciated that this ratio also corresponds to the ratio of the actual length of the second support surface to the actual length of the first support surface, which is a significant aspect of the invention.

The width of the support apparatus, as measured in the transverse direction, is preferably between 100 mm and around 250 mm, more preferably between 120 mm and around 200 mm, more preferably between 140 mm and around 160 mm, and in some embodiments is most preferably around 150 mm. In one alternative embodiment, the apparatus is preferably around 300 mm in width. In a further alternative embodiment, the apparatus is preferably around 450 mm in width.

In one preferred embodiment, the apparatus is formed as a unitary structure from a relatively firm, lightweight closed-cell foam material. It should be appreciated, however, that any suitable material or combination of materials could be used, including various plastics, rubber, timber, metal, or the like. In the case of relatively hard materials such as timber, metal or rigid plastics, a softer surface lining or covering material may additionally be used for enhanced comfort. In some embodiments, the support surfaces, ridges and valley formation may also be smoothly contoured for enhanced comfort and/or functionality.

In one embodiment, the apparatus incorporates a vibration mechanism adapted, in use, to induce muscle relaxation in the user's spine.

According to a second aspect, the invention provides a support apparatus adapted positioning beneath the lower back of a user, the support apparatus including:
a base;
a first support formation adapted for positioning substantially beneath the coccyx or sacrum of the user;
a second support formation spaced apart from and below the first support formation, and adapted for positioning substantially beneath one or more of the thoracic vertebrae of the user; and
a transverse recess formation disposed between the first and second support formations, and adapted for positioning substantially beneath one or more of the lumbar vertebrae of the user;
such that in use the apparatus tends to induce flexion in the lumbar region and lordosis in the thoracic region of the user's spine.

Preferably, the apparatus is adapted to be used with the user in a generally semi-supine position, with the feet and/or lower legs at least partially elevated. Preferably, the second support formation is adapted for positioning substantially beneath the T-8 to T-10 thoracic vertebrae of the user. Preferably also, the transverse recess is adapted for positioning substantially beneath the L-4 or L-5 lumbar vertebrae of the user.

According to a third aspect, the invention provides a method for treatment or prevention of lower back pain in a user, the method including the steps of:
providing a support apparatus as previously defined;
positioning the first support surface or support formation substantially beneath the coccyx or sacrum of the user;
positioning the second support surface or support formation substantially beneath one or more of the thoracic vertebrae of the user;
positioning the transverse valley formation or recess generally beneath one or more of the lumbar vertebrae of the user; and
thereby inducing flexion in the lumbar region and lordosis in the thoracic region of the user's spine.

Preferably, the second support surface or support formation is adapted for positioning substantially beneath the T-8 to T-10 thoracic vertebrae of the user, when oriented in a semi-supine position. Preferably also, the transverse valley formation or recess is adapted for positioning substantially beneath the L-4 or L-5 lumbar vertebrae of the user when oriented in the semi-supine position.

According to further aspects, the invention provides a method and apparatus for promoting a tendency for flexion in the lumbar region of the spine, while simultaneously promoting a tendency for lordosis in the thoracic region of the spine, thereby to induce a relaxation response in the lower back of the user.

### BRIEF DESCRIPTION OF THE DRAWINGS

Preferred embodiments of the invention will now be described, by way of example only, with reference to the accompanying drawings in which:

FIG. 1 is a perspective view showing a support apparatus according to a first embodiment of the invention, in the operative position, beneath the lower back of the user;

FIG. 2 is a perspective view showing the support apparatus of FIG. 1;

FIG. 3 is a reverse perspective view showing the support apparatus of FIGS. 1 and 2;

FIG. 4 is a side elevation view of the support apparatus;

FIG. 5 is a diagrammatic side elevation view of the support apparatus similar to FIG. 4, indicating the primary dimensional parameters;

FIG. 6 is an end elevation view of the support apparatus;

FIG. 7 is a perspective view similar to FIG. 2, showing a second embodiment of the invention, being substantially wider than the first embodiment; and

FIG. 8 is a reverse perspective view of the second embodiment of the invention shown in FIG. 7.

### PREFERRED EMBODIMENTS OF THE INVENTION

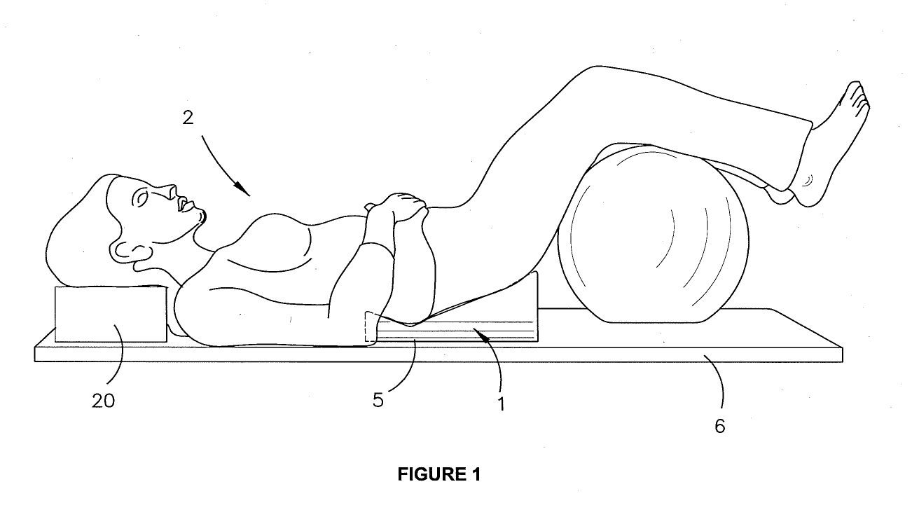

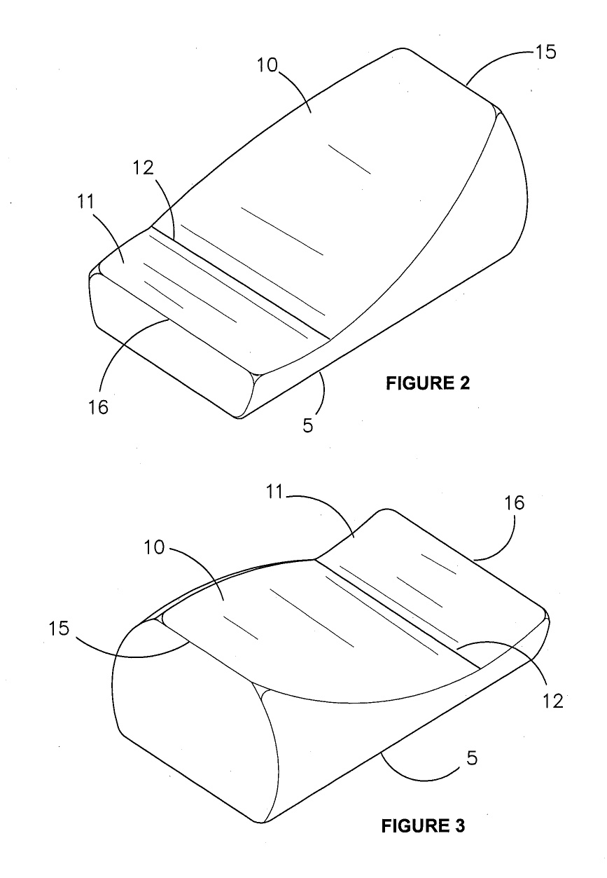

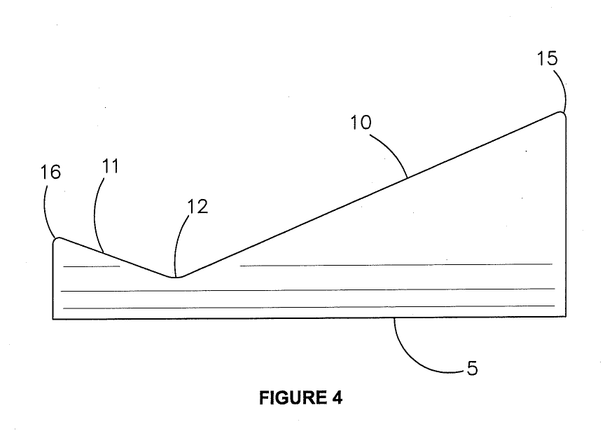

Referring to the drawings, the invention provides a support apparatus 1 adapted to be positioned beneath the lower back of a user 2, relaxing in a generally horizontal semi-supine position, as best seen in FIG. 1. The apparatus includes a base 5 adapted for positioning on a stable platform 6, such as a floor, a bench, a table or the like. In some embodiments, the base and the platform may be effectively integral, or may be adapted releasably to interlock. The apparatus further includes respective first and second inclined support surfaces 10 and 11, disposed to diverge upwardly from a generally transverse substantially V-shaped valley formation 12. The valley formation is disposed between, and defined generally by the intersection of, the first and second support surfaces.

In the embodiment illustrated, the first and second support surfaces 10 and 11 are generally flat and planar in configuration. It should be appreciated, however, that these surfaces may be smoothly curved or otherwise contoured, or may incorporate various dimples, ribs, grooves, or other suitable formations, textures or patterns if desired to enhance comfort, functionality and/or aesthetics within the overall functional constraints of the apparatus.

The first inclined support surface 10 defines a first generally transverse ridge formation 15 on one side of the valley formation 12 (the side disposed toward the user's legs in the operative position). Similarly, the second inclined support surface 11 defines a second generally transverse ridge formation 16 on the opposite side of the valley formation (the side disposed toward the user's torso in the operative position).

In operation, the first ridge formation 15, or at least the first inclined support surface 10, is positioned substantially beneath the coccyx (tailbone) or sacrum of the user, the second ridge formation 16 is positioned substantially beneath the T-8 to T-10 thoracic vertebrae, and the intermediate valley formation is positioned generally beneath the L-4 or L-5 lumbar vertebrae. In this way, under the influence of gravity, the first ridge formation induces flexion (or a tendency toward flexion) in the lumbar region of the spine, while the second ridge formation simultaneously induces lordosis (or a tendency toward lordosis) in the thoracic region of the spine.

In other words, the lumbar spine that is normally curved concavely is urged toward a convex, or at least toward a less concave curvature, while the thoracic spine that is normally convexly curved, is urged toward a concave, or at least a less convex curvature. By contrast, those skilled in the art will appreciate that conventional wisdom has hitherto dictated that lumbar supports, cushions, backrests and the like should be shaped to do precisely the opposite: that is, to induce or increase lordosis in the lumbar spinal curvature, and induce or increase flexion in the thoracic spinal curvature.

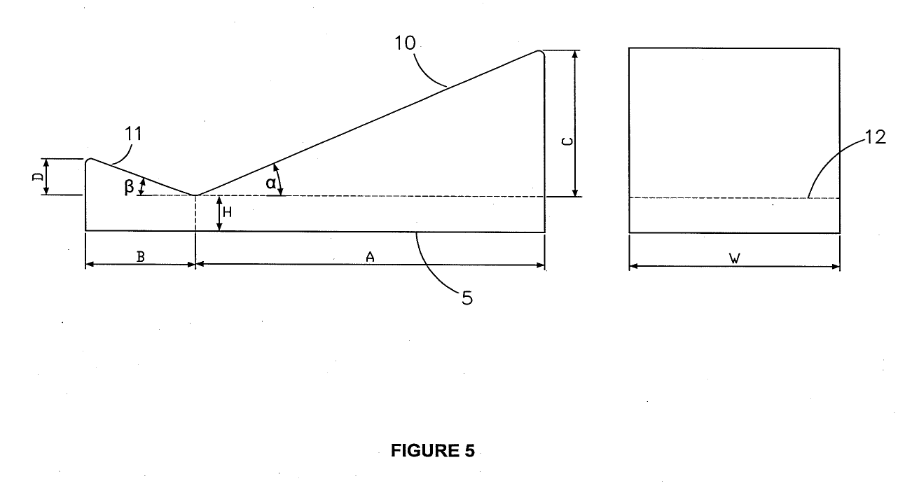

Turning now to describe the shape and configuration of the apparatus in more detail, and primarily with reference to FIG. 5, the first support surface 10 is inclined at an angle a that is preferably between 10° and 25°, and ideally around 20° to the horizontal. The second support surface 11 is similarly inclined at an angle β that is preferably between 15° and 25°, and ideally around 20° to the horizontal. The first and second support surfaces thus define an included angle in the vicinity of the valley formation that is preferably between 135° and 145°, and ideally around 140° .

References to these angles of inclination generally assume for convenience of description that the base and the supporting platform are oriented horizontally. It should be appreciated, however, that in some embodiments, the base and/or the supporting platform may themselves be inclined, in which case the specified angles of the inclined support surfaces may need to be modified to compensate, in whole or in part, for the orientation of the supporting platform. In some embodiments, the apparatus may even be used in a generally vertical orientation, although this may require some supplementary support to induce an effect similar to the operation of gravity on the user in the semi-supine position.

The lowermost region or floor of the valley formation is positioned at a height “H” that is preferably between 20 mm and around 40 mm, and ideally around 30 mm, above the base. The first ridge formation defined by the first inclined support surface is disposed at a height “C” that is preferably between 80 mm and around 110 mm, and more preferably around 95 mm, above the valley formation. The second ridge formation defined by the second inclined support surface is disposed at a height “D” that is preferably between 20 mm and around 30 mm, and ideally around 25 mm, above the floor of the valley formation. The ratio of the maximum height of the second inclined support surface to the maximum height of the first inclined support surface (D:C) is preferably between 0.25 and around 0.35, and ideally around 0.3.

The projected length “A” of the first inclined support surface is preferably between 180 mm and around 280 mm, and ideally between 200 mm and around 250 mm. The projected length “B” of the second inclined support surface is preferably between 40 mm and around 80 mm, and ideally between 50 mm and around 70 mm. The ratio of the projected length of the second inclined support surface to the projected length of the first inclined support surface (B:A) is preferably between 0.25 and around 0.35, and ideally around 0.3.

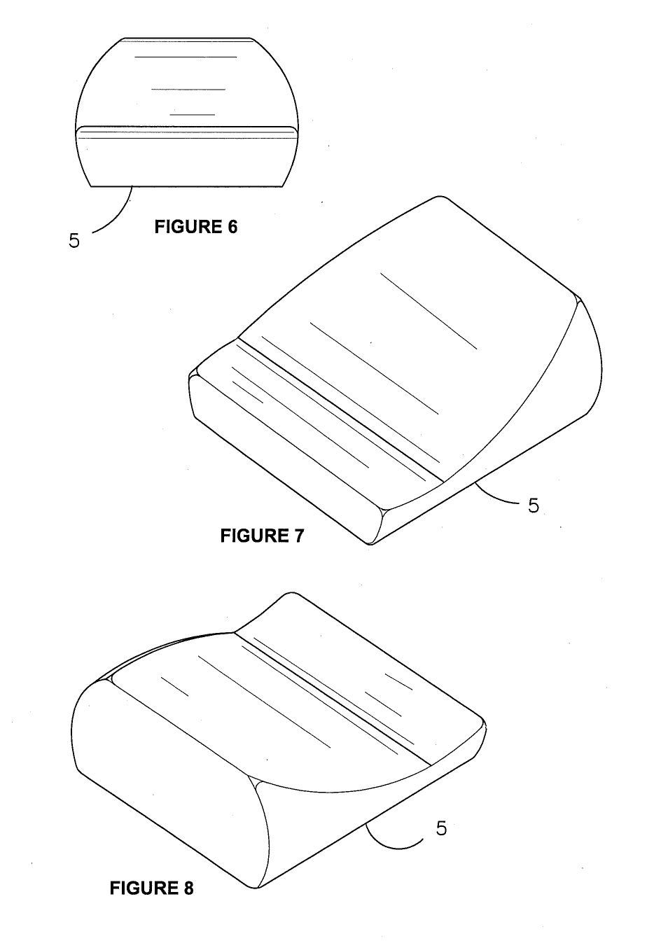

The width of the support apparatus in this first embodiment, as measured in the transverse direction, is preferably around 150 mm. In a second embodiment of the invention, as best seen in FIGS. 7 and 8, the width is around 300 mm. In a further embodiment (not shown) the width of the apparatus is around 450 mm.

More specific measurements for one embodiment are indicated in Table 1 below, in which three variations are described, for use respectively by subjects of three different heights. The various dimensions specified relate primarily to a support apparatus adapted for use by adults within a relatively normal height range. It should be appreciated, however, that the apparatus may be scaled proportionately and/or optimised anatomically for use with children, or with abnormally short or tall adults.

TABLE 1
(Refer to FIG. 5)

| Subject | | | | | | | | | | |
|---|---|---|---|---|---|---|---|---|---|---|
| Height* | angle | angle | length A | length B | Ratio | height C | height D | Ratio | Profile | width |
| (mm) | α | β | (mm) | (mm) | B/A | (mm) | (mm) | D/C | type | (mm) |
| 1545 | 22.5° | 22.5° | 205 | 56 | 0.27 | 85 | 23.2 | 0.27 | 6 | 150 |
| 1725 | 22.5° | 22.5° | 226 | 62 | 0.27 | 93.6 | 25.7 | 0.27 | 1 | 150 |
| 1905 | 22.5° | 22.5° | 248 | 67 | 0.27 | 103 | 27.8 | 0.27 | 7 | 150 |

Specific measurements for a further embodiment are indicated in Table 2 below, in which again variations are described for use respectively by subjects of different heights, as indicated.

TABLE 2
(Refer to FIG. 5)

| Subject | | | | | | | | | | |
|---|---|---|---|---|---|---|---|---|---|---|
| Height* | angle | angle | length A | length B | Ratio | height C | height D | Ratio | Profile | width |
| (mm) | α | β | (mm) | (mm) | B/A | (mm) | (mm) | D/C | type | (mm) |
| 1545 | 20° | 20° | 216 | 66 | 0.30 | 78.8 | 24.0 | 0.30 | 6 | 150 |
| 1725 | 20° | 20° | 236 | 72 | 0.30 | 85.9 | 26.2 | 0.30 | 1 | 150 |
| 1905 | 20° | 20° | 256 | 78 | 0.30 | 93.1 | 28.4 | 0.30 | 7 | 150 |
| 1995 | 20° | 20° | 266 | 81 | 0.30 | 96.7 | 29.5 | 0.30 | 8 | 150 |
| 2085 | 20° | 20° | 276 | 84 | 0.30 | 100.2 | 30.6 | 0.30 | 9 | 150 |

In both these embodiments, the height of the valley corresponding to distance H in each variation is substantially constant, at approximately 29 mm.

It should be understood that the indicated subject heights are a nominal only, sitting approximately midway within a suitable range in each case. For example, a nominal subject height of 1545 mm would be suitable for subjects in the height range of 1460 mm to around 1640 mm, and a nominal subject height of 1725 mm would be suitable for subjects in the height range of 1640 mm to around 1820 mm. Similarly, a nominal subject height of 1905 mm would be suitable for subjects in the height range of 1820 mm to around 2,000 mm, a nominal subject height of 1995 mm would be suitable for subjects in the height range of 1910 mm to around 2090 mm, and a nominal subject height of 2085 mm would be suitable for subjects in the height range of 2,000 mm to around 2179 mm.

In some embodiments, the apparatus is formed predominantly from a relatively firm closed cellular foam material, with an effective hardness of at least Shore C 25, and more preferably at least Shore C 30. In some embodiments, the foam material may be heat sealed, to provide further hardness and to reduce overall compressibility.

Some embodiments utilise a relatively firm (or substantially rigid) core structure to ensure that the overall dimensional integrity of the apparatus is maintained in a stable manner during use, and a softer covering layer over the core for increased comfort. In some embodiments a plurality of different materials may be utilised, so as to tailor the firmness and resilience characteristics in different regions and thereby to optimise the performance of the apparatus in terms of both functionality and comfort.

It will be appreciated that depending on the specific material properties, and in particular if softer foam materials are utilised, the dimensional parameters of the apparatus in the relaxed condition may need to be marginally modified, to allow for the expected extent of resilient defamation, and hence the resultant or effective dimensional parameters, in use. Such variations should be understood to be within the scope of the invention as defined.

Turning now to describe the method of use of the apparatus in more detail, the user initially rests in a generally horizontal semi-supine position, with knees bent and feet or lower legs supported in an elevated position by a stable supporting platform or surface 6, which may be provided by a bench, chair or exercise ball, as best seen in FIG. 1. A small cushion 20 or other suitable support is preferably placed under the user's head for comfort. The support apparatus 1 is then placed in position under the lower back, with the base 5 resting on the support platform, the first ridge substantially beneath the coccyx or sacrum, and the second ridge generally beneath the T-8 to T-10 thoracic vertebrae. This results in the transverse valley formation being positioned generally beneath the L-4 or L-5 lumbar vertebrae.

As previously described, in combination with the effect of gravity on the user, the apparatus thereby tends to induce flexion (i.e. curvature that is kyphotic, tending toward kyphosis or at least tending toward reduced lordosis) in the lumbar region, which is normally lordotic. At the same time, the apparatus tends to induce curvature that is lordotic (or tending toward lordosis or at least tending toward reduced kyphosis) in the thoracic region of the user's spine, which is normally kyphotic.

The user relaxes in this position for a predetermined period of time, which may vary according to the nature of the condition being treated, but may for example, be for 1 or 2 minutes, 5 minutes, 10 minutes, 20 minutes or 30 minutes at a time. The treatment is then repeated at regular intervals for as long as required, or indefinitely as part of a maintenance or prevention program. Again, the prescribed intervals will vary according to the nature of the individual and the condition to be treated, but may range from several times per day, to several times per week. Ideally, the treatment program is also accompanied by an exercise program based on Pilates, yoga or the like, to improve the user's core strength, flexibility, circulation, general health and treatment response. Furthermore, the treatment may also be accompanied by a physical therapy program. For example, a treatment program in accordance with the present invention could be used prior to, during and/or after a physical therapy program to enhance the effectiveness of the physical therapy.

While the practical utility of the invention is not intended to be constrained by any particular scientific or anatomical theory, it is postulated that the unexpected degree of efficacy of the invention results, at least in part, from the lumbar spine of the user being supported in a novel and unfamiliar orientation, in which the brain has no memory of a pre-existing muscle tone pattern. Consequently, and surprisingly, it responds by “letting go” or at least partially relaxing any pre-existing tension or hypertonicity in the lower back. Preliminary clinical trials have demonstrated significant and unexpected benefits in terms of relieving both the duration and intensity of lower back pain in long-term sufferers. Early test results also indicate that with regular use of the apparatus as a preventative measure, the onset of lower back pain may be ameliorated or avoided altogether.

In this context, it should be understood that the shape and flexibility of the spine varies significantly from person to person. In some instances, the actual changes in curvature in the lumbar and thoracic spine of the user may be minimal. It may also be, for example, that in use a gap remains between the L-4 or L-5 lumbar vertebrae and the floor of the valley formation. The material factor is that the support apparatus induces a tendency for the spinal curvatures to change so as to adopt unfamiliar positions or modes of curvature as described, and thereby to trigger the desired unconscious localised muscle relaxation response.

Of course, treatment response may vary significantly from person to person, according to a variety of individual factors including the precise nature of the condition to be treated. Depending upon these factors, some patients may experience significant improvements in a short space of time, while others may experience no significant change.

By providing a simple and effective solution to many forms of lower back pain as well as a preventative measure that is safe, efficient, convenient, inexpensive, painless, non-invasive, non-addictive and devoid of significant side-effects, the invention at least in preferred embodiments represents a practical and commercially significant improvement over the prior art.

Although the invention has been described with reference to specific examples, it will be appreciated by those skilled in the art that the invention may be embodied in many other forms.

1. A support apparatus adapted for positioning beneath the lower back of a user in a generally semi-supine position, the support apparatus including:
a base for positioning on a platform;
first and second inclined support surfaces disposed to diverge upwardly from a generally transverse valley formation defined between the first and second support surfaces;
the first inclined support surface being adapted for positioning substantially beneath the coccyx or sacrum of the user;
the second inclined support surface being adapted for positioning substantially beneath one or more of the thoracic vertebrae of the user; and
the valley formation being adapted for positioning substantially beneath one or more of the lumbar vertebrae of the user;
thereby tending to induce an abnormal curvature in the user's spine.

2. An apparatus according to claim 1, wherein the base is adapted for stable positioning on a floor, and wherein the apparatus is adapted for use with the user in a generally semi-supine position on the floor.

3. An apparatus according to claim 1, wherein the first inclined support surface defines a first generally transverse ridge formation, and the second inclined support surface defines a second generally transverse ridge formation.

4. An apparatus according to claim 3, being sized and positioned such that in use, the first ridge formation is positioned substantially beneath the coccyx or sacrum, the second ridge formation is positioned substantially beneath the T-8 to T-10 thoracic vertebrae, and the valley formation is positioned substantially beneath the L-4 or L-5 lumbar vertebrae, thereby simultaneously to induce flexion in the lumbar region of the spine and lordosis in the thoracic region of the spine.

5. An apparatus according to claim 1, wherein the first support surface is generally planar and is inclined upwardly at an angle of between 15° and around 25° to the horizontal.

6. An apparatus according to claim 1, wherein the second support surface is generally planar and is inclined upwardly at an angle of between 15° and around 25° to the horizontal.

7. An apparatus according to claim 1, wherein the first and second inclined support surfaces intersect to define an included angle at or adjacent the valley formation that is between 135° and around 145°.

8. An apparatus according to claim 1, wherein a lowermost region of the valley formation is positioned at a height of between 20 mm and around 40 mm above the base.

9. An apparatus according to claim 3, wherein the first ridge formation defined by the first inclined support surface is disposed at a height of between between 80 mm and around 110 mm, above the valley formation.

10. An apparatus according to claim 3, wherein the second ridge defined by the second inclined support surface is disposed at a height of between 20 mm and around 30 mm, above the valley formation.

11. An apparatus according to claim 1, wherein a ratio of the height of the second inclined support surface to the height of the first inclined support surface (each measured at the uppermost point of the respective ridge with respect to the valley) is between 0.25 and around 0.35.

12. An apparatus according to claim 1, wherein a projected length of the first inclined support surface is between 200 mm and around 250 mm.

13. An apparatus according to claim 1, wherein a projected length of the second inclined support surface is between 50 mm and around 70 mm.

14. An apparatus according to claim 1, wherein a ratio of the projected length of the second inclined support surface to the projected length of the first inclined support surface is between 0.25 and around 0.35.

15. An apparatus according to claim 1, formed as a unitary structure from a closed-cell foam material.

16. A support apparatus adapted positioning beneath the lower back of a user in a generally semi-supine position, the support apparatus including:
a base;
a first support formation adapted for positioning substantially beneath the coccyx or sacrum of the user;
a second support formation spaced apart from and below the first support formation, and adapted for positioning substantially beneath one or more of the thoracic vertebrae of the user; and
a transverse recess formation disposed between the first and second support formations, and adapted for positioning substantially beneath one or more of the lumbar vertebrae of the user;
such that in use the apparatus tends to induce flexion in the lumbar region and lordosis in the thoracic region of the user's spine.

17. A method for treatment or prevention of lower back pain in a user, the method including the steps of:
providing a support apparatus according to claim 1;
positioning the first support surface or support formation substantially beneath the coccyx or sacrum of the user;
positioning the second support surface or support formation substantially beneath one or more of the thoracic vertebrae of the user;
positioning the transverse valley formation or recess generally beneath one or more of the lumbar vertebrae of the user; and
thereby inducing flexion in the lumbar region and lordosis in the thoracic region of the user's spine.

18. A method according to claim 17, wherein the second support surface or support formation is adapted for positioning substantially beneath the T-8 to T-10 thoracic vertebrae and the transverse valley formation or recess is adapted for positioning substantially beneath the L-4 or L-5 lumbar vertebrae of the user when oriented in a substantially semi-supine position.

19. An apparatus for promoting a tendency for flexion in the lumbar region of the spine, while simultaneously promoting a tendency for lordosis in the thoracic region of the spine, thereby to induce a relaxation response in the lower back of the user.

20. A method for inducing a relaxation response in the lower back of a user, comprising the steps of promoting a tendency for flexion in the lumbar region of the spine, while simultaneously promoting a tendency for lordosis in the thoracic region of the spine.
